(19) United States
(12) Patent Application Publication
(10) Pub. No.: US 2025/0389578 A1
(43) Pub. Date: Dec. 25, 2025

(54) LUMINANCE CALIBRATION DEVICE

(71) Applicant: ADMESY B.V., Ittervoort (NL)

(72) Inventor: Ruud Martin Jozef BOUTEN, Ittervoort (NL)

(21) Appl. No.: 18/879,131

(22) PCT Filed: Jun. 28, 2023
(86) PCT No.: PCT/EP2023/067690

§ 371 Date: Dec. 26, 2024

(30) Foreign Application Priority Data
Jul. 1, 2022 (EP) 22182485.7

(51) Int. Cl. G01J 1/02; G01J 1/04; G01J 1/08; G01J 1/42

(52) U.S. Cl. CPC G01J 1/0295; G01J 1/0488; G01J 1/08; G01J 1/4228

(57) ABSTRACT

A luminance calibration device comprises a light source and a light scattering structure for scattering the light of the light source and having a light outlet port. In use a light measurement device to be calibrated can be positioned to capture light from the light outlet port. At least one multichannel optical sensor is associated with the light scattering structure. The multichannel optical sensor is adapted to capture the luminance at least ten different wavelengths comprised in the light emitted by the light source and scattered by the light scattering structure.

### FIELD OF THE INVENTION

The invention relates to the calibration of light measurement equipment. In particular the invention relates to a luminance calibration device used as a reference for calibrating light measurement equipment such as a spectrometer.

### BACKGROUND OF THE INVENTION

Manufacturers of light measurement equipment need to indicate the accuracy of their products by referring to a standard used by international reference institutes such as but not limited to National Institute of Standards and Technology (NIST) in the USA and Physikalisch-Technische Bundesanstalt (PTB) in the Federal Republic of Germany.

These institutes refer as a basis to the light emitted by a so called black body light source. The output of this is used to calibrate a first reference light measurement device, which may be a spectrometer or a monochromator. The first reference light measurement device is used to measure and calibrate a transfer light source. The transfer light source is used by the institute to verify measurements by light measurement devices that have to be accredited. The transfer light source is the so called working standard. A common transfer light source includes a Halogen lamp and an integrating sphere used to scatter the light from the lamp. The sphere has a light outlet port. In use a light measurement device to be calibrated can be positioned in front of the outlet port to capture scattered light from the sphere.

A problem that is encountered in practise is that the light source, e.g. a Halogen lamp, changes over time. Depending on the characteristics of the particular light source the luminance and colorpoint of the light can drift over time. This can happen during a long duration measurement as well as over the guaranteed lifetime of the light source. The measurements during calibration of the transfer light source takes relatively a long time (may be several hours), whereby the reference measurements contain already an uncertainty at the start of using the light source. Moreover the light source drifts during its lifespan (which may be 40-50 hours for a Halogen lamp), which creates additional uncertainty during use for calibration of light measurement devices. The total of uncertainties may be quantified higher than 1%-1,5% in calibration measurements in which the transfer light source is used as a reference light source.

The present invention has for an object to provide a luminance calibration device which can be used as a transfer light source which reduces the uncertainty in the calibration of light measurement equipment.

### SUMMARY OF THE INVENTION

According to one aspect of the invention a luminance calibration device comprises a light source and a light scattering structure for scattering the light of the light source. The light scattering structure having a light outlet port, wherein in use a light measurement device to be calibrated can be positioned to capture light from the light outlet port. The luminance calibration device furthermore comprises at least one multichannel optical sensor associated with the light scattering structure. The at least one multichannel optical sensor is adapted to capture the luminance at at least 10 different wavelengths comprised in the light emitted by the light source and scattered by the light scattering structure.

In an embodiment the at least one multichannel optical sensor is adapted to capture the luminance at at least thirty different wavelengths, preferably at a number of different wavelengths in the range 32-46. In this embodiment the multichannel optical sensor is thus able to detect at least 30, preferably 32 to 46 different “colors” in the light emitted by the light source, which provides a sufficient color sensitivity such that the measurements by the sensor can be used as a reference measurement for calibrating high end measurement devices.

In an embodiment the at least one multichannel optical sensor comprises an array of photodiodes and an array of filters matched with the array of photodiodes, wherein the array of filters comprises different bandpass filters. It is noted here that the term “array” in this context means a grouped set of photodiodes or filters. This can be one row or column, or multiple rows and columns. Although in practise the array is usually rectangular, it does not have to be rectangular. Every channel of the sensor corresponds to at least one photodiode.

The number of different filters in the array and corresponding channels in the sensor, should at least be 10 to obtain a sufficient color sensitivity of the multichannel optical sensor. In practise sensors having 64 or 256 photodiodes and thus 64 or 256 channels are feasible. To be able to use the luminance calibration device for calibrating high-end light measurement equipment, at least 30 different filters should be in the array. In a practical embodiment the number of different filters and corresponding channels in the sensor is in the range 32-46.

In an embodiment a plurality of multichannel optical sensors is arranged to simultaneously capture the luminance at said different wavelengths comprised in the light. In this embodiment the device thus has two or more multichannel optical sensors, that are the same and each capture the same light and each provide a signal representative for the spectral power distribution of the light. These measurement signals coming from the sensors can be compared by an algorithm to detect a deviation between the signals. If the deviation comes above a predetermined threshold, it is an indication that the reading of the sensors cannot be used as a reference measurement anymore. As a reference measurement used for calibration purposes the mean of the signals of the plurality of sensors can be used. This mitigates small discrepancies in the measurements caused by the fact than no sensor is exactly the same. Another option is to use the measurement of one sensor as a reference measurement in a calibration and the measurement of another sensor as a check signal to detect the mentioned deviation between the sensors.

In an embodiment the light scattering structure comprises an integrating sphere and a baffle positioned inside the sphere, wherein the light source is positioned to provide light inside the integrating sphere and such that the baffle shields the outlet port from direct light from the light source, and wherein the at least one multichannel optical sensor is positioned inside the sphere such that the sensor is shielded by the baffle from direct light from the light source.

In an embodiment the integrating sphere has a light entrance port, wherein the light source is positioned outside the integrating sphere in front of the light entrance port.

In a further embodiment the light entrance port comprises an adjustable light inlet aperture.

In an embodiment the integrating sphere has an adjustable light inlet aperture, wherein the light source is positioned outside the integrating sphere in front of the light inlet aperture. It is however also conceivable that the light source is positioned inside the integrating sphere.

In an embodiment the light source is a Halogen lamp. A Halogen lamp emits broad spectrum light. The luminance is distributed over at least the visible spectrum, i.e. wavelengths that are visible. For light measurement equipment used to test for example displays, a luminance calibration device using a Halogen lamp as a light source is suitable as a transfer light source, or “work standard”.

In another embodiment the light source may be adapted to adjust the spectral power distribution of the light emitted by the light source. For example a multicolor LED (RGB LED) can be used as a light source, which can be adjusted.

In an embodiment the luminance calibration assembly comprises a luminance calibration device as described in the above and a computer. The computer comprises:
a data memory in which reference measurement data of the optical sensors is stored, obtained during the calibration of the luminance calibration device, said reference measurement data representing spectral power distribution captured by the at least one multichannel sensor of the light emitted by the light source; and
a processing unit connected to the data memory and to the at least one multichannel optical sensor, said processing unit being configured to determine a deviation between real-time measured data of the at least one multichannel optical sensor and the stored reference measurement data.

In a further embodiment the computer is connected to the light source, and the processing unit is configured to generate a control signal for the light source to adjust the spectral power distribution thereof, based on said deviation between real-time measured data of the at least one multichannel optical sensor and the stored reference measurement data. This embodiment can be used with light sources of which the spectrum can be actively controlled, e.g. a multicolor LED. Thus the spectral power of the light source can be automatically be corrected to correspond to the original spectral power. The effect of spectral drift is thus actively eliminated or at least mitigated.

Another aspect of the invention relates to a method for calibrating a luminance calibration device as described in the above. In the method:
a reference light measurement device (e.g. a monochromator) measures the light of the luminance calibration device;
the at least one multichannel optical sensor of the luminance calibration device measures the light of the luminance calibration device;
the at least one multichannel optical sensor is calibrated on the basis of the measurement of the reference measurement device and the measurement of the at least one multichannel optical sensor.

Yet another aspect of the invention relates to a method for calibrating a light measurement device (Device Under Test) using a luminance calibration device as described in the above. In the method:
the light measurement device measures the light emitted by the light source of the luminance calibration device;
simultaneously, the at least one multichannel optical sensor measures the light emitted by the light source of the luminance calibration device;
the light measurement device is calibrated by using the measurement of the at least one multichannel optical sensor as a reference.

### BRIEF DESCRIPTION OF THE DRAWINGS

FIG. 1 illustrates schematically a luminance calibration device according to the invention,

FIG. 2 illustrates schematically another luminance calibration device according to the invention,

FIG. 3 illustrates schematically a further embodiment of a luminance calibration device according to the invention,

FIG. 4 shows a spectrum of a Halogen lamp,

FIG. 5 illustrates an array of optical filters for use in a luminance calibration device according to the invention,

FIG. 6 illustrates schematically an optical multichannel sensor for in a luminance calibration device according to the invention, and

FIG. 7 illustrates the effect of small bandwidth filters of an array in the spectral domain.

### DETAILED DESCRIPTION

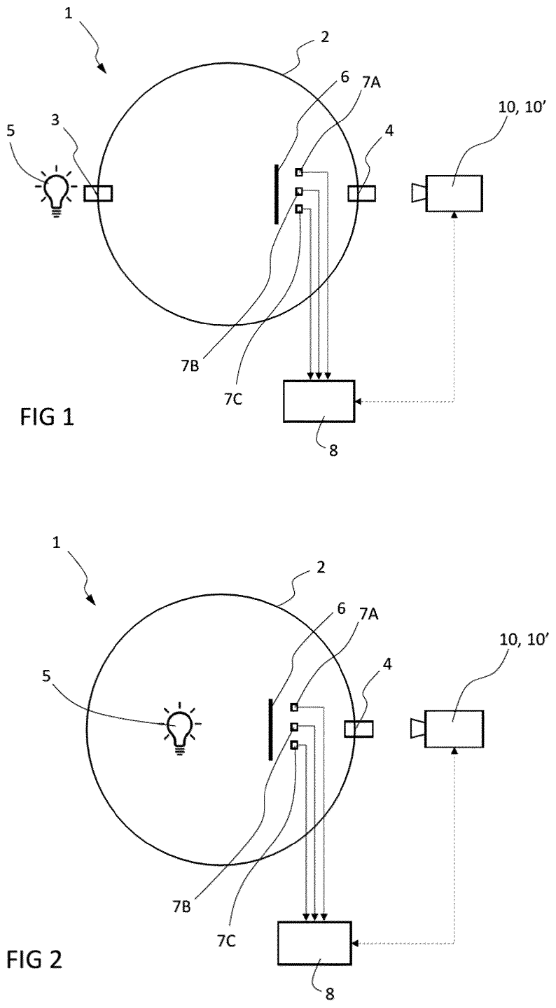

In FIGS. 1 and 2 two embodiments of an integrating sphere calibration device 1 are illustrated schematically.

The integrating sphere calibration device of FIG. 1 comprises an integrating sphere 2 having a light inlet port 3 and a light outlet port 4. A light source 5 is positioned in front of the light inlet port 3 to provide light inside the integrating sphere 2. The light inlet port 3 may be a light inlet aperture which is manually or automatically adjustable to adjust the amount of light entering the sphere 2. The integrating sphere 2 scatters the light that enters through the light inlet port 3. A baffle 6 is positioned inside the sphere 2 to shield the outlet port 4 from direct light coming from the light source 5. A light measurement device 10 to be calibrated can be positioned in front of the outlet port 4 and observes diffuse light coming from the inside of the integrating sphere through the outlet port 4. This light measurement device 10 is also called a “Device Under Test” or “DUT”. In practise this light measurement device 10 may be a spectrometer which can be used to test screens of computer devices, tablet computers, smartphones etc.

The integrating sphere calibration device 1 of FIG. 2 differs from the one of FIG. 1 in that the light source 5 is positioned inside the sphere 2. For the invention this is not essential. Important is that there is a light source 5 and a light scattering structure, in both examples (FIG. 1 and FIG. 2) comprising an integrating sphere 2 and a baffle 6.

The light source 5 may be a Halogen lamp. A Halogen lamp emits broad spectrum light. The luminance is distributed over at least the visible spectrum, which is for example shown in FIG. 4. However, the invention is not limited to devices using a Halogen lamp. Also other light sources are conceivable. For example a multicolor LED could also be used as will be described further below.

Three multichannel optical sensors 7A, 7B, 7C are arranged inside the sphere 2. The sensors 7A, 7B, 7C are arranged behind the baffle 6 such that the sensors 7A, 7B, 7C are shielded by the baffle 6 from direct light from the light source 5. The multichannel optical sensors 7A, 7B, 7C are adapted to capture the luminance at different wavelengths comprised in the light emitted by the light source 5 and scattered in the sphere 2. Although in the example three sensors 7A, 7B, 7C are shown, it is possible to have one or two sensors, or more.

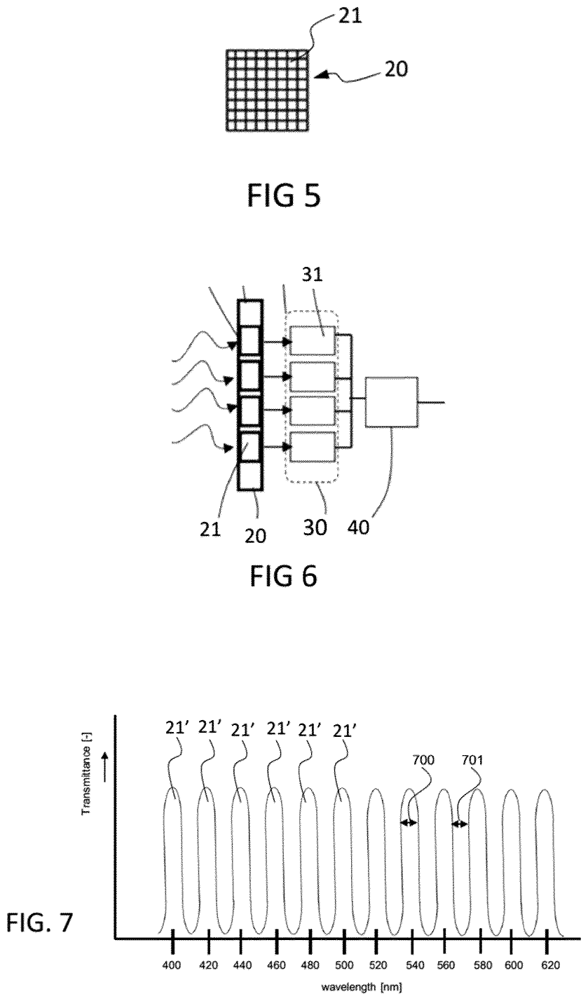

In a preferred embodiment the multichannel optical sensors comprises an array of photodiodes and an array of filters matched with the array of photodiodes. The photodiodes can be incorporated in a photo-sensitive layer. The array of filters comprises different narrow bandpass filters. Such a sensor, if having sufficient filters/channels, can accurately indicate the spectral “fingerprint” of the light it detects. In FIG. 5 is shown an example of an array 20 of filters 21, in this example a square array of 8×8=64 filters. Each of the 64 filters 21 may be a different narrow bandpass filter that allows light with a certain narrow wavelength range to pass. In FIG. 7 the transmittance of light at several wavelengths of an array of filters is illustrated. The filters are indicated by reference numeral 21′ in FIG. 7. The bandwidth of one of the filters 21′ is indicated by reference numeral 700. Here the filters 21′ are distributed regularly over the spectrum, but there may be more distance between the filters 21′. In other words the distance indicated by reference numeral 701 may be larger, and does not have to be the same between the consecutive filters 21′. It is also possible to have two or more of the same bandpass filters in the array. The filter array 20 is associated with an array of optical sensors in this case photodiodes. In FIG. 6 is illustrated how a filter array 20 is positioned in front of an optical sensor array 30, such that each individual filter 21 of the filter array 20 is aligned with a sensor 31 of the sensor array 30. As mentioned the optical sensors 31 may be photodiodes made into a photosensitive layer. The multichannel optical sensor 7A, 7B, 7C may in essence be configured like this. Thus the multichannel optical sensors 7A, 7B, 7C can detect the luminance of the light at different selected wavelengths (cf. FIG. 7). The multichannel optical sensor 7A, 7B, 7C can be connected to a signal processing unit 40 shown in FIG. 6, which may be part of a processing unit 8 or may be connected to a processing unit 8 (cf. FIGS. 1-3).

The sensors 7A, 7B, 7C are connected with a processing unit 8. The light measurement device 10 (Device Under Test) can also be connected with the processing unit 8 as is indicated by the dashed double arrow. The processing unit 8 is configured to process the measurement signals of the sensors 7A, 7B, 7C and the measurement signal of the light measurement device 10. The mean value of the measurements of the sensors 7A, 7B, 7C may be used as the reference signal which is compared to the measured signal of the light measurement device 10. This reference signal is thus a real time calibration signal that is used to calibrate the light measurement device 10.

Before the sensors 7A, 7B, 7C can be used to generate a reference signal, they have to be calibrated themselves. This can be done in a standard institute like PTB or NIST. The basis is the light emitted by a so called black body light source. This is an “absolute” reference which is used to calibrate a first reference light measurement device, which may be a spectrometer or a monochromator. The first reference light measurement device is used to measure and calibrate the integrating sphere calibration device 1 (“transfer light source”). The measurement device 10 in FIG. 1 is thus during the calibration the first reference measurement device, which is indicated by reference numeral 10′. The first reference measurement device 10′ provides the reference signal. This reference signal is used to calibrate the multichannel sensors 7A, 7B, 7C for every calibration wavelength comprised in the light emitted by the light source 5. Once the sensors 7A, 7B, 7C have been calibrated, the integrating sphere calibration device 1 can be used to calibrate other light measurement devices 10.

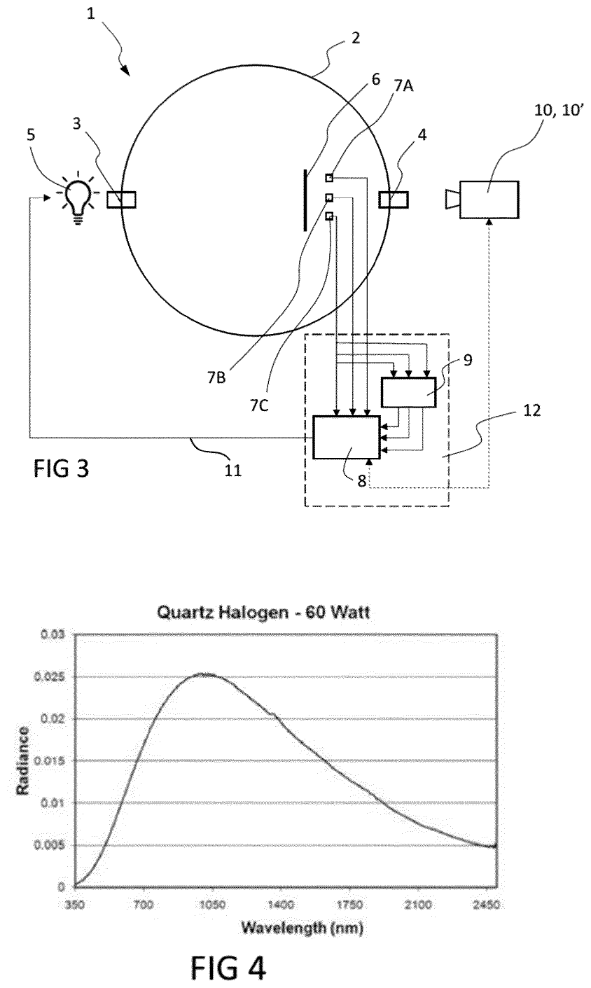

In a possible embodiment, which is schematically illustrated in FIG. 3 the light source 5 may be adapted to adjust the spectral power distribution of the light emitted by the light source 5. One may think of a multicolor (RGB) LED. A data memory 9 is provided in which reference measurement data of the optical sensors 7A, 7B, 7C is stored, obtained during the calibration of the luminance calibration device 1. The stored reference measurement data represents spectral power distribution captured by the multichannel optical sensors 7A, 7B, 7C of the light emitted by the light source 5. The device 1 furthermore comprises a processing unit 8 connected to the data memory 9, to the multichannel optical sensors 7A, 7B, 7C and to the light source 5. The processing unit 8 is configured to determine a deviation between real-time measured data of the multichannel optical sensors 7A, 7B, 7C and the stored reference measurement data. The processing unit 8 generates a control signal, indicated by reference numeral 11 for the light source 5 to adjust the spectral power distribution thereof, based on said deviation.

In the above embodiments the processing unit 8 and/or the data memory 9 may be incorporated in a computer 12 which can be combined with the integrating sphere calibration device 1.

1. A luminance calibration device comprising:
a light source;
a light scattering structure for scattering the light of the light source and having a light outlet port, wherein in use a light measurement device to be calibrated can be positioned to capture light from the light outlet port;
at least one multichannel optical sensor associated with the light scattering structure, wherein the multichannel optical sensor is adapted to capture the luminance at at least ten different wavelengths comprised in the light emitted by the light source and scattered by the light scattering structure.

2. The luminance calibration device according to claim 1, wherein the at least one multichannel optical sensor is adapted to capture the luminance at at least thirty different wavelengths, preferably at a number of wavelengths in the range 32-46.

3. The luminance calibration device according to claim 1, wherein the at least one multichannel optical sensor comprises an array of photodiodes and an array of filters matched with the array of photodiodes, wherein the array of filters comprises different bandpass filters.

4. The luminance calibration device according to claim 3, wherein the array of filters comprises at least ten different filters.

5. The luminance calibration device according to claim 1, wherein a plurality of multichannel optical sensors is arranged to simultaneously capture the luminance at said different wavelengths comprised in the light.

6. The luminance calibration device according to claim 1, wherein the light scattering structure comprises an integrating sphere and a baffle positioned inside the integrating sphere, wherein the light source is positioned to provide light inside the integrating sphere and such that the baffle shields the outlet port from direct light from the light source, and wherein the at least one multichannel optical sensor is positioned inside the integrating sphere such that the sensor is shielded by the baffle from direct light from the light source.

7. The luminance calibration device according to claim 6, wherein the integrating sphere has a light entrance port, wherein the light source is positioned outside the integrating sphere in front of the light entrance port.

8. The luminance calibration device according to claim 7, wherein the light entrance port comprises an adjustable light inlet aperture.

9. The luminance calibration device according to claim 1, wherein the light source is a Halogen lamp.

10. The luminance calibration device according to claim 1, wherein the light source is adapted to adjust the spectral power distribution of the light emitted by the light source.

11. The luminance calibration assembly comprising a luminance calibration device according to claim 1 and a computer, said computer comprising:
a data memory in which reference measurement data of the optical sensors, is stored, obtained during the calibration of the luminance calibration device, said reference measurement data representing spectral power distribution captured by the at least one multichannel sensor of the light emitted by the light source; and
a processing unit connected to the data memory and to the at least one multichannel optical sensor, said processing unit being configured to determine a deviation between real-time measured data of the at least one multichannel optical sensor and the stored reference measurement data.

12. The luminance calibration assembly according to claim 11, wherein the computer is connected to the light source, and wherein the processing unit is configured to generate a control signal for the light source to adjust the spectral power distribution thereof, based on said deviation between real-time measured data of the at least one multichannel optical sensor and the stored reference measurement data.

13. A method for calibrating a luminance calibration device, the luminance calibration device comprising:
a light source;
a light scattering structure for scattering the light of the light source and having a light outlet port, wherein in use a light measurement device to be calibrated can be positioned to capture light from the light outlet port;
at least one multichannel optical sensor associated with the light scattering structure, wherein the multichannel optical sensor is adapted to capture the luminance at at least ten different wavelengths comprised in the light emitted by the light source and scattered by the light scattering structure;
wherein:
a reference light measurement device measures the light of the luminance calibration device,
the at least one multichannel optical sensor of the luminance calibration device measures the light of the luminance calibration device,
the at least one multichannel optical sensor is calibrated on the basis of the measurement of the reference measurement device and the measurement of the at least one multichannel optical sensor.

14. A method for calibrating a light measurement device (Device Under Test) using a luminance calibration device, the luminance calibration device comprising:
a light source;
a light scattering structure for scattering the light of the light source and having a light outlet port, wherein in use a light measurement device to be calibrated can be positioned to capture light from the light outlet port;
at least one multichannel optical sensor associated with the light scattering structure, wherein the multichannel optical sensor is adapted to capture the luminance at least ten different wavelengths comprised in the light emitted by the light source and scattered by the light scattering structure;
wherein:
the light measurement device measures the light emitted by the light source of the luminance calibration device,
simultaneously, the at least one multichannel optical sensor measures the light emitted by the light source of the luminance calibration device,
the light measurement device is calibrated by using the measurement of the at least one multichannel optical sensor as a reference.

15. The luminance calibration device according to claim 3, wherein the array of filters comprises at least thirty different filters.

16. The luminance calibration device according to claim 10, wherein the light source is a multicolor LED.
